(19) United States
(12) Patent Application Publication
(10) Pub. No.: US 2006/0235129 A1
(43) Pub. Date: Oct. 19, 2006

(54) Multifunctionally usable coating dispersion for printing substrates

(76) Inventors: Josef Weigl, Munich (DE); Christian Weigl, Munich (DE); Konrad Goebel, Stephaskirchen/Haidholzen (DE)

Correspondence Address: MARGER JOHNSON & MCCOLLOM, P.C., 210 SW MORRISON STREET, SUITE 400, PORTLAND, OR, 97204, US

(21) Appl. No.: 10/546,419

(22) PCT Filed: Aug. 14, 2003
(86) PCT No.: PCT/EP03/09038

§ 371 Date: Dec. 22, 2005

(30) Foreign Application Priority Data
Feb. 21, 2003 (DE) 103 07 494.5

(51) Int. Cl. D21H 11/00; C08K 9/04

(52) U.S. Cl. 524/445; 162/135; 162/181.6

(57) ABSTRACT

The disclosure relates to a coating dispersion for coating printing substrates, especially paper and paperboard. Said dispersion is constituted of at least one defined percentage of water, a defined percentage of a swellable phyllosilicate and a defined percentage of a cross-linking agent. The cross-linking agent forms a bond with at least one functional group of the phyllosilicate as well as with at least one functional group of the printing substrate. The invention also relates to a method for producing a coated printing substrate onto which a coating dispersion is mechanically applied and dried, whereby the coating dispersion comprises at least the aforementioned components.

### RELATED APPLICATION DATA

This application claims priority and benefit of PCT/EP2003/009038, filed 14 Aug. 2003, which claims priority from German application no. 10307494.5, filed 21 Feb. 2003, the entire contents of which are hereby incorporated by reference.

### FIELD OF THE INVENTION

The invention relates to a coating dispersion for coating printing substrates, especially paper and paperboard.

### BACKGROUND OF THE INVENTION

Economical aspects, as well as the rapid development in the non-impact area, prevail in the paper manufacturing markets today. The quality demands of paper, especially coated products, are increased simultaneously with the requirements of a less expensive production. In order to achieve good profitability the value of a product must be increased while production costs are declined at the same time. These partially contradictory demands, such as quality increase, reduction of area weight with increasing production speeds, can no longer be met with conventional finishing procedures, or with increased costs only.

Today, ways are increasingly being sought by means of the selection of special, inexpensive raw materials, the preparation and application of which achieve good printing results in mass paper goods, but also in specialty papers. Modern application systems in particular allow the inexpensive production of paper with functional coatings and coats. For example, coated and improved paper types for newspapers and magazines are available on the market, which are produced by means of the use of the so-called film transfer technique (film press application).

Even traditional newspapers are printed in the four-color printing process on light, coated newspaper, whereas they become just as interesting for product advertisement, as the inserts found in newspapers already are today.

For the so-called coldset printing, for example, printing plants, are looking for additional utilization possibilities for capacities available during the day, which, however, place certain demands on the coated papers to be processed.

Furthermore, multi-purpose writing and printing papers are, for example, written on, used for copying, and/or are printed by means of offset and new ink print processes.

It is expected that the demand of multi-functional papers, especially for inkjet print, will increase substantially. The same is expected for the use of laser printers and copiers.

The paper to be used must also meet the requirement of a lower area weight, whereas the same is not only demanded for environmental reasons, but also for reasons of freight charge savings for the shipping of printed products.

In the case of LWC paper, the demand of additional reduction of area weight can be met almost exclusively with the amount of coat applied.

Limitations are reached with the reduction of the area weight mass of the substrate, especially due to stability reasons, below which the coated types may not fall. Therefore, efforts have been made for many years to achieve sufficient fiber coverage and an optimum printability with increasingly thinner layers. Especially in the gravure sector respective tests have been performed with a low application grammage.

While calendered natural papers, so-called SC papers (super calendered), are suitable both for gravure and offset printing, this is not possible with coated LWC papers both due to different speed and printing quality requirements. For example, the high binding agent requirement of offset paper not only has an adverse effect on gravure, but also on coldset printing (physical printing ink drying), flexoprinting, and inkjet printing, because the binding agent strongly reduces the porosity of the coated paper, which correspondingly has an adverse effect on the absorption and ink penetration behavior, or the chromatography effect of the said print process, respectively.

It is further known that the specific surface area of coated paper is reduced with an increasing proportion of binding agent under constant calendering conditions, i.e. the high specific surface area of the coating pigment used is largely lost depending on the proportion of binding agent.

The specific surface area of a coating pigment is reduced from 11.5 m²/g with 12.5 parts of binder, depending on the calendering conditions (soft calender) with coated papers to 0.3 m²/g, which has a correspondingly adverse effect on the ink penetration behavior, and the printability.

This has an even more dramatic effect on the silicic acids used today with a specific surface area of up to 750 m²/g, as they are being used in high-quality inkjet formulations.

Furthermore, they are relatively expensive compared to common coating pigments. Due to their high capillarity, porosity, and specific surface area, their demand for a binding agent is very high (up to 30-40 parts of binding agent). Binding agents in turn, are also relatively expensive, and by themselves cover a large part of the surface so that the active surface is reduced. Furthermore, only low solid contents can be achieved with these pigments.

A high solid content on the other hand is a prerequisite for the—less expensive—coating at high speeds.

This means that the porosity of the paper texture, expressed as the pore volume, pore size distribution, specific surface area, or/and capillary absorbency, affects some individual characteristics that are important for the printing paper to a more or less large extent.

More than 80% of the complaints in the offset area are closely related to the interaction of printing ink/paper, and the increasing print speeds.

Test results have shown that ink penetration speeds and capillary structure (high microporosity with certain pore radii and pore volumes) of the printing substrate are the decisive factors for the separation effect of the printing ink.

With a large specific surface area (microporosity) the mineral oil of the printing ink preferred penetrates the paper with a small amount of binding agent, while the pigment remains at the surface with the rest of the binding agent. With an increasing specific surface area, the separation ability, or the chromatography effect, respectively, is reduced, which leads to corresponding problems.

This is also a decisive factor for the quality development of ink jet and flexoprinting (separation of solvent water and additives of ink).

Future requirements of coated printing papers essentially are the improvement of productivity, quality, quality consistency, and above all, functionality of the products produced.

The development of an inexpensive paper with an expanded functionality could close the currently existing gap between individual paper qualities.

A few years ago it was detected that there are reactive compounds (organophilic bentonite), which undergo spontaneous reactions with an incoming printing ink, particularly a gravure ink containing toluene. These physical/chemical reactions result in the coated surface closing completely, thus forming a “reactive barrier” that produces very good gravure printability results even with low coat applications.

Aqueous organophilic phyllosilicates on bentonite basis for the coating of paper are known from DE-A-4038886.

EP-A-0192252 describes a similar organophilic bentonite, and its use in coating colors on the basis of organic solvents.

Both cases are a modification of the bentonite boundary layer with organic additives, which, among others, causes a hydrophobing of bentonite.

A method for the improvement of organic solvents containing the holdout of printing inks, finishes, and coating colors on paper is known from DE-A-3506278, in which an organophilic complex of a swellable smectic phyllosilicate and of an onium compound is introduced into the fibrous pulp, or into the surface of the paper, whereby the organophilic complex forms a barrier by means of the reaction with the organic solvent.

Similar aqueous fine suspensions of an organophilic phyllosilicate are known from DE-A-0542215, which consist of a swellable, cation exchangeable phyllosilicate, and a quarternary organic onium salt reacted with the same, and containing 3 to 30 wt.-% of polyvinyl alcohol based on the organophilic phyllosilicate.

A coating for a printing substrate according to the ink jet print process is known from EP 0710742A2, which is essentially characterized in that a three-layer silicate is modified by means of acidic activation of an alkali, or earth alkali smectite, or by means of incorporation of metallic oxide bridges into its coating structure, and contains about 10-50 wt.-parts, preferred 20 to 25 wt.-parts of binding agent and other additives.

A coating for a printing substrate according to the ink jet print process is known from U.S. Pat. No. 4,792,487, which essentially consists of a montmorrilonite with a high swelling capability, and which may contain a pigment with a high surface, such as synthetic silicate, or calcium carbonate, as well as a water-insoluble binding agent.

DE 4438305.3 describes a pigment for the coating of printing paper, especially a pigment for self-inking paper on the basis of an acid activated alkali and/or earth alkali smectite, which is characterized in that the alkali and/or earth alkali smectite is partially activated with at least one Brønstedt acid, and/or Lewis acid, and has a content of amorphous silicate of a maximum of 15 wt.-%.

EP0755989A2 describes a coating pigment mixture with improved gravure suitability of calcium carbonate, low amounts of swellable phyllosilicate, and with an acidic activated phyllosilicate, as well as a gravure binder, such as a dispersion agent, thickening agent, and a defoamer. Application grammages are stated as 4-12 g/m², preferred 6-10 g/m² per side.

Coating pigments on the basis of swellable, smectic clays are also known from EP-A-0283300.

In addition to the smectic clays, these coating pigments can also contain up to 30% of secondary or extender pigments, such as kaolin, or calcium carbonate. The pigment application is not higher than 5 g/m², preferred not higher than 1 g/m². As the smectic clay, for example, naturally available sodium bentonite (Wyoming bentonite) may also be used. It has a swelling capacity of 50 ml (2 g in 100 ml of water).

Despite of its high swelling capacity, its adhesion to paper without any binding agent is very poor, which is why the printability according to the offset print process (water contact) is a problem. Furthermore, the use of bentonites with interchangeable sodium and calcium ions is described.

The papers coated with these bentonites had only a low pick resistance, which is why in almost all examples a binding agent, such as starch or latex, had to added in order to improve the adhesion to the paper fiber.

EP 0688376B1 describes a method for the production of lightface paper at high production speeds, which is suitable both for offset and gravure processes.

For the realization of the production of such papers a minimum amount of pulp, as well as a limitation of the amount of recycled paper, the use of natural binding agents, such as starch, or modified starch, respectively, co-binders, such as CMC, and common additives, such as pigments, stearates, as well as a mixture of a swellable phyllosilicate on one hand, and common mineral coated pigments, such as kaolin, and/or CaCO₃ on the other hand, at a grammage ratio of 20:60 to 95:5, are necessary.

A method for the production of coated papers using a coating containing binding agents and pigments is known from DE-B-736450, whereas bentonite or a similar swelling clay serves as the binding agent in the coating color. However, a characterization of the material used is not being performed.

A coating pigment is described in DE-A-4217779 and EP-A-0572037, which is fixable on paper and paperboard essentially without any binding agent, and which results in coated surfaces that can be gravure and offset printed. This pigment consists at least of 30 wt.-% of a swellable phyllosilicate, and has a swelling volume of 5 to 30 ml (based on a suspension of 2 g in 100 ml of distilled water). As the swellable phyllosilicate, mainly minerals of the smectite group, preferred bentonite, or synthetic hectorite, are used. The remaining 70 wt.-% of the coating pigment may consist of conventional coating pigments, such as kaolin, CaCO₃, etc.

With formulations without any binder, and with coating applications larger than 1 g/m², however, the lack of offset capability and wet pick resistance present a problem. This nearly always occurs particularly due to the physical direction.

### SUMMARY OF THE INVENTION

It is the task of the present invention to provide a coating dispersion for coating printing substrates, which can be produced inexpensively, in particular without any binding to the associated advantages and high AP content, and which can be processed at high machine speeds. Furthermore, a printing substrate coated with this coating dispersion is to be usable both for conventional print processes, and for special print processes.

The task is solved according to the invention by means of the object of claim 1. Preferred further embodiments of the invention are the object of the sub-claims.

According to the invention, a coating dispersion for coating printing substrates, especially paper and paperboard, is constituted of at least one predetermined portion of water, a predetermined portion of at least one swellable phyllosilicate, and a predetermined portion of a cross-linking agent, which forms a bond with at least one functional group of the phyllosilicate, as well as with at least one functional group of the printing substrate.

According to the present invention, a chemical bond means at least one bond from the group of bonds, which has covalent bonds, hydrogen bonds, van der Waals bonds, ionic bonds, and such.

According to a particularly preferred embodiment, the coating dispersion is applied on the printing substrate of an oven-dry area weight of between 0.5 and 6 g/m², preferred of between 0.6 and 5 g/m², particularly preferred of between 0.8 and 4 g/m², and according to a preferred embodiment, in particular of <4 g/m².

The swellable phyllosilicates are understood to be phyllosilicates according to the invention, such as bentonites, alkali bentonites, such as Wyoming bentonite, montmorillonite, hectorite, saponite, nontronite, alkali phyllosilicates, earth alkali phyllosilicates, calcium bentonite, and such.

Due to the requirements of a strong swelling, or delamination, respectively, and a good adhesive effect (but unusable viscosity), or a low swelling and high solid content (but poor adhesion effect), the application possibility of such pigments particularly with large additions, and without binding agents, has failed thus far. Since the adhesive effect of the swellable phyllosilicates already only exists with the fibers, and not among each other, application quantities of over 0.5 g/m² are impossible due to stability reasons. In particular the adhesion is lost with the use of water.

Bentonites are three-layer aluminum silicates, in which the central AlO₆ octahedron layers are chemically linked to two SiO tetrahedron layers. Isomorphic replacement of Al³⁺ by, for example, Mg²⁺ in the middle lamellae produces negative layer charges, which are compensated by cations on interstitials. These cations can be hydrated, and are therefore mobile. Depending on the charge density, the exchange capacity is between 60 and 120 mVal per 100 g. The high swelling volume causes a simple delamination of the bentonite into the individual lamellae, which leads to high viscosity and thixotropic flow behavior.

The aspect ratio in bentonite is 20 to 50 in the dry state, and increases after complete delamination theoretically to about 1000. Therefore, these are extremely thin, flexible platelets, which have a specific surface area of up to 750 m²/g in suspension.

Due to its high surface and its structure, delaminated bentonites have a good adhesion during the application of thin layers, which are hardly usable, however, due to the viscosities and low solid content already mentioned.

It is assumed that the leading cause of the adhesion effect of strongly delaminated bentonites to pulp is a certain formation of hydrogen bridges, as well as possibly the bond via so-called van der Waals forces.

The range of such hydrogen bonds, as well as that of the van der Waals gravities, is limited, and can only form if the distance of the fiber to the delaminated bentonite is smaller than about 3 Å.

This means that the delaminated bentonite and the fiber must be brought to this small distance to one another during the dehydration process.

It can easily be imagined that each decrease or reduction of these bond surfaces, or a reduction of the OH, or SiOH groups responsible for these bonds, whether by means of an application amount that is too high, or by means of coating pigments, such as caolin and/or CaCO₃, which allocate the contact locations, or which prevent the necessary approximation of fibers and delaminated bentonite, always lead to a reduction of the adhesion properties, or stability, respectively.

When contacted by water, hydration sheaths are formed by means of the absorption of water of more than 20 Å in diameter at the fiber and at the delaminated bentonites, which largely prevent, or abrogate the formation of hydrogen bridges and the effect of van den Waals forces, which also explains the low wet pick resistance (lack of offset capability) even with strongly delaminated bentonite, and at low coating applications without any binding agents. Finally, the same process occurs, as with an uncoated paper, which completely loses its stability once it is immersed in water.

The testing during the development of a “functional coat” with phyllosilicates without any binding agents with coating applications of up to 4 g/m² per side therefore concentrates on new bonding systems between the fiber and the phyllosilicate, or between phyllosilicates among each other, respectively, which generally differ from the physical bonding mechanisms, such as the hydrogen bonds.

Disadvantages of an increase of bonding strength by means of the addition of natural and water resistant, synthetic binding agents, are, for example, the loss of active surface, the adhering of microcapillaries, or specific surface areas, respectively, problems with production and preparation, increase in costs, etc. Another aspect of the invention is therefore the use of chemical additives that develop highly stable bonding forces by means of cross-linking reactions, even when wetted with water.

Alkali activated bentonites show excellent cross-linking results with high stability values with increasing swelling, or delamination, respectively, and specific surface area.

Smectic phyllosilicates are, for example, bentonite, montmorillonite, hectorite, saponite, or nontronite. From this group, the use of bentonite and montmorillonite is preferred. The swelling capability of the phyllosilicates is higher with the alkali phyllosilicates, than with the earth alkali phyllosilicates. Natural alkali bentonites (e.g. Wyoming bentonite), for example, can be used as swellable ones.

The required swelling capability may also be produced by means of alkali activation of earth alkali phyllosilicates (e.g. calcium bentonite). An excessively high swelling capability, however, results in coatings having a high viscosity so that the highly swellable phyllosilicates are generally added at smaller portion. The less swellable earth alkali phyllosilicates may be added at higher portion.

These phyllosilicates can be dispersed largely into the individual lamellae in aqueous suspensions under shear action, and have a high portion of SiOH groups, or a high surface, respectively.

A high swelling capability with a high specific surface area ensures a good cross-linking reaction, but with the already described production and manufacturing problems. For production lines with low production speeds, as well as for certain application grammage ranges with a higher gram base paper, as well as by means of mixtures with other coating pigments, high quality coated functional coats can also be produced with these phyllosilicates.

The phyllosilicates, or alkali activated bentonites, respectively, used for the purposes according to the invention, are, for example, commercially available products, such as Printosil, Lightcoat, Optigel 800, and Optigel 805.

As a highly purified, modified phyllosilicate (100% Na montmorillonite), Optigel 805, for example, has a specific surface area of about 700 m²/g and a Brookfield viscosity (100 rpm) of about 800 mPa•s at a ink content of 5% after extensive swelling, or delamination at a swelling capability of 70 ml/g. Due to its low solid content, this product may be used only with a so-called extender, or on very slow production lines, respectively with respective base paper.

Preferred alkali-activated bentonites with a solid content of between 5 to 30%, especially products between 12 to 27% at a Brookfield viscosity of about 100-700 mPa•s, and a specific surface area after swelling of 100-700 m²/g, preferred 200-500 m²/g are used.

According to a particularly preferred embodiment the portion of the phyllosilicate at the coating dispersion is larger than 70 wt.-% oven-dry.

The solid content of the swellable phyllosilicate at the coating dispersion is preferred 5 to 35 wt.-% oven-dry, preferred 8 to 20 wt.-% oven-dry. Furthermore, such a dispersion has a Brookfield viscosity within a range of 50-2000 mPa•s at 100 rpm, and preferred is between 250-1200 mPa•s. Furthermore, silicates with a high surface also have a certain cross-linking reaction.

According to the present invention at least one component from a group of components is understood as the cross-linking agent, which includes wet strength agents, such as formaldehyde, melamine-formaldehyde resins, aliphatic epoxy resins, epichlorohydrin resins, polyamide-polyamine epichlorohydrin resins, zirconium compounds, glyoxal compounds, polyisocyanates, alkyl ketone dimers (AKD), alkyl succinc anhydrides (ASA), and polyvinyl amines, and such.

It has been found that with some of these wet strength agents cross-linking reactions apparently occur with phyllosilicates, such as with pulps, or hydrocolloids, respectively, such as starch, guar, CMC, PVAl, etc., which at a coating application of up to 4 g/m² result in an excellent internal bond strength, or dry and wet strengths, respectively, even without any binding agents, that are comparable to a coated offset paper with 12-14 parts of binder. This surprising result can only be explained in that the cross-linking reactions occur with the silicol groups (SiOH groups) of the phyllosilicate among each other, or with the —OH, or carboxyl groups of the fiber of the base paper on one hand, and with the silicol groups of the phyllosilicate on the other hand.

It has been shown that with zirconium compounds only minimal strength improvements can be achieved with HF resins, MF resins, ASA, AKD, and that with epichlorohydrin resins a marked improvement, and with glyoxal, or modified glyoxal and polyisocyanates by far the best results are achieved.

According to prior art it is further known that zirconium salts, such as ammonium zirconium carbonate (AZC) predominantly react with —COOH groups, and react only weakly with —OH groups.

The effect of HF resins, MF resins, and epichlorohydrin resins is based mainly on the fact that the products predominantly cross-link among themselves, thus protecting the already existing fiber-to-fiber bonds from destruction by water.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 illustrates a self-condensation reaction UF resin.

FIG. 2 illustrates the reaction of glyoxal compounds with OH groups.

FIG. 3 illustrates glyoxal polyacrlyamide derivatives obtained from a reaction of glyoxal with low-molecular polyacrylamide (PAM), resulting in a net (matrix) structure, with a relatively high aldehyde group portion.

### DETAILED DESCRIPTION

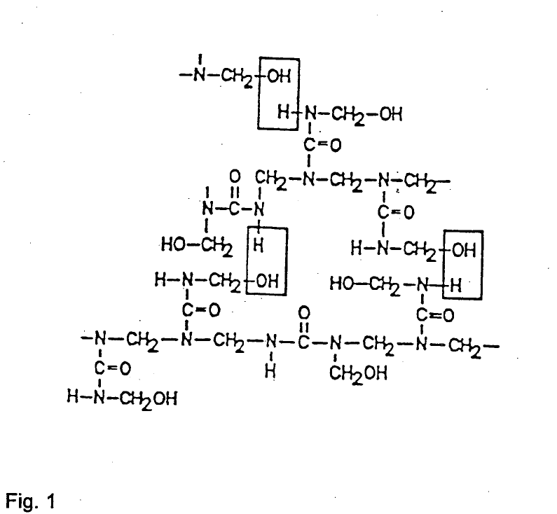

An example of the self-condensation reaction is UF resin. It is a three-dimensional network that is also called cross-linked network (compare FIG. 1).

A certain proportion of this wet strength agent additionally also reacts with carboxyl, aldehyde, or hydroxyl groups.

In modified and stabilized glyoxal resins (reactive polyhydroxylate compounds), such as glyoxal polyacrylamide derivatives, and polyioscyanates, reactions with OH groups preferred occur, which obviously also could react with SiOH groups (see FIG. 1).

According to a particularly preferred embodiment glyoxal, particularly a modified glyoxal compound is used as the cross-linking agent. In a further, particularly preferred embodiment, polyisocyanate is used.

Furthermore, the cross-linking agent can be stabilized, and/or its charging character, and/or its interfacial properties modified, or adjusted to the required properties criteria.

As such water soluble polymers, for example, polyvinyl alcohols, polyethylene glycols, polyvinyl pyrrolidones, and such are used.

According to a particularly preferred embodiment, based on the portion of the cross-linking agent, between 2 and 10 wt.-% oven-dry, preferred between 4 to 7 wt.-% oven-dry of polyvinyl alcohol are added.

According to a further particularly preferred embodiment, a portion of between 2 and 6 wt.-% oven-dry, preferred between 3 and 5 wt.-% oven-dry of polyethylene glycol are added to the cross-linking agent, based on the cross-linking agent.

It is within the scope of the invention that further additives can be added to the cross-linking agent, which according to a particularly preferred embodiment are selected from the group of additives, containing optical brighteners, thickening agents, biocides, preservatives, buffer solutions, catalysts, inhibitors, dispersing agents, complexing agents, and such.

According to a particularly preferred embodiment 0.1 to 1 wt.-% of a commercial product (CP), preferred between 0.2 and 0.4 wt.-% of a commercial product of an optical brightener are added to the cross-linking agent.

With a coating dispersion, a portion of cross-linking agent of between 0.1 to 6 wt.-% oven-dry, based on the pigment, preferred of between 0.6 and 7.4 wt.-% oven-dry, based on the pigment, and particularly preferred of between 0.8 and 3 wt.-%, based on the pigment, is added according to the present invention.

According to a particularly preferred embodiment, at least one extender pigment is added to the coating dispersion, which is selected for a group of pigments having precipitated silicate, acidic activated bentonite, silicates produced with a hydrothermal process, aluminum hydroxide, and such.

According to a further particularly preferred embodiment at least one additional pigment is added to the coating dispersion, which is selected from a group of pigments having kaolin, ground calcium carbonate, precipitated calcium carbonate, talc, zeolite, titanium dioxide, and such.

In mixtures with other coating pigments, such as kaolin, ground calcium carbonate (GCC), precipitated calcium carbonate (PCC), talc, precipitated silicates, acidic activated bentonites, silicates produced with a hydrothermal process, and aluminum hydroxides, a functional coat can be produced with these coating pigments with alkali activated bentonites, depending on the aspired paper properties, of between 5 and 20 parts, preferred of between 8 and 15 parts, without the addition of binding agent with 0.8 to 3 parts of modified cross-linking agent at application grammages of between 0.8 to 4 g/m², which leads to good printing results in all print processes.

With a higher amount of addition, i.e. larger than 25% of such other coating pigments, binding agent amounts of between 1.5 and 5 parts are necessary, whereas binders with a high OH group content, such as PVAl, are preferably suitable for the cross-linking reactions.

In such pigment mixtures, alkali activated bentonites with a higher swelling capability, or viscosity, respectively, may also be produced due to the higher solid contents even with rapid production lines.

Depending on the bentonite content, the solid content of the coating to be processed in this manner is between 12 and 35 wt.-% oven-dry.

With the use of bentonite, dispersing agents are also purposefully used. In any case the area-related application weight is below 4 g/m² and paper side. An application grammage of between 0.8 and 4 g/m² and side is preferred. Particularly with 100% bentonite content in the coating, the application amount may also be below 0.8 g/m².

According to a further particularly preferred embodiment a binding agent may additionally be added to the previously described coating dispersion, which is selected from a group of binding agents having synthetic binding agents, natural binding agents, polyvinyl alcohol, starch, carboxymethyl cellulose, latex, and such.

Particularly with a portion of the extender pigment of larger than 35 wt.-% based on the total pigment portion, a binding agent portion of between 0.5 and 10 wt.-% oven-dry, preferred of between 1 and 7 wt.-% oven-dry, particularly preferred of between 1.5 and 5 wt.-% oven-dry is used.

According to a preferred embodiment a binding agent portion of between 0.5 and 10 wt.-% oven-dry, preferred of between 1 and 7 wt.-% oven-dry, and particularly preferred of between 1.5 and 5 wt.-% oven-dry is used in a portion of an additional pigment larger than 25 wt.-% oven-dry, based on the total pigment portion of the coating dispersion.

It is within the scope of the present invention that particularly with the use of an extender pigment the portion of the binding agent portion used in the coating dispersion tends to be lower than the required amount of binding agent with the use of another pigment, as has been previously described.

According to a particularly preferred embodiment a bond with both the phyllosilicate and the pulp, or the hydrocolloids, respectively, such as starch, guar, carboxymethyl cellulose (CM), polyvinyl alcohol, and such occurs by means of the cross-linking agent.

Here in particular, the functional groups of the cross-linking agent react with the functional groups of the swellable phyllosilicate, particularly the silicol groups. Furthermore, the functional groups of the cross-linking agent react with the functional groups of the printing substrate, such as the pulp, particularly its free hydroxyl groups.

With the use of a mixture product made of glyoxal with polyethylene glycol, and/or polyvinyl alcohol, the functional groups of the cross-linking agent are free hydroxyl groups.

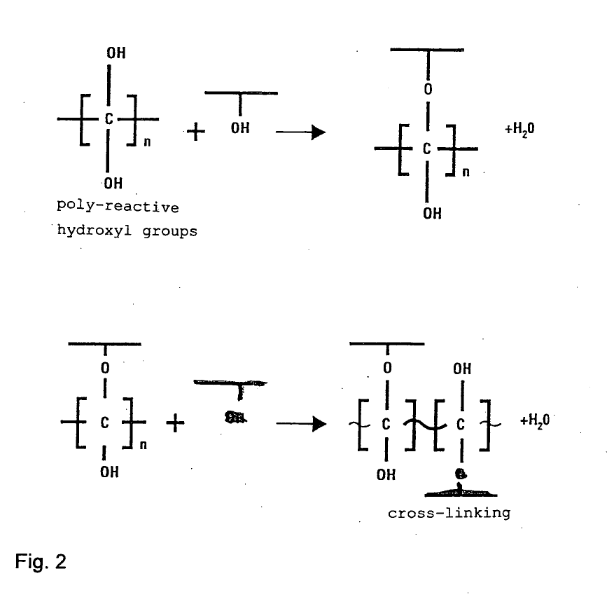

Especially the binding-active groups are understood to be free hydroxyl groups (see FIG. 2).

With the use of a mixture product made of glyoxal with polyacrylamdie, the functional groups of the cross-linking agent are free aldehyde groups.

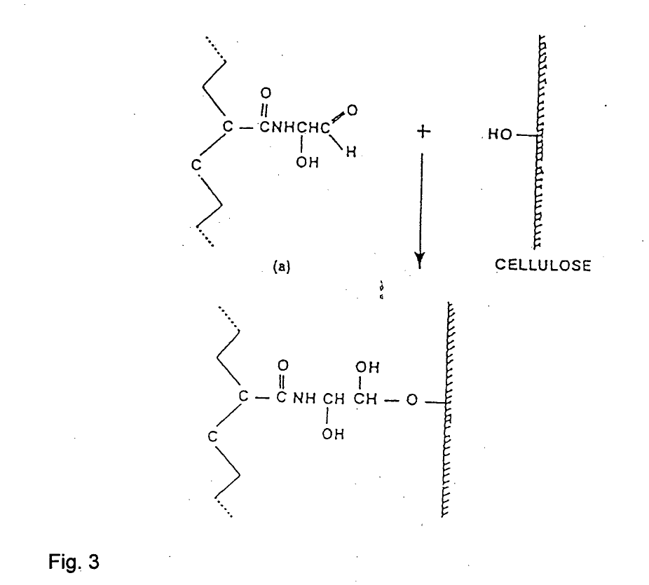

FIG. 2 illustrates the reaction of glyoxal compounds with OH groups. Glyoxal polyacrlyamide derivatives are obtained from a reaction of glyoxal with low-molecular polyacrylamide (PAM), whereas this results in a net (matrix) structure, and with a relatively high aldehyde group portion (see FIG. 3).

These free aldehyde groups can react with the free OH groups of the printing substrate (e.g. cellulose), or with the SiOH groups, respectively, of the phyllosilicates.

It is within the scope of the present invention that other functional groups of the cross-linking agent may also be used for binding the phyllosilicates, or the pulp, and/or hydrocolloids, respectively.

According to a further particularly preferred embodiment the cross-linking agent effects a temporary strengthening of the printing substrate, and/or of the coat, which particularly already occurs during the production process in the paper machine, and/or in the coating machine.

According to a further particularly preferred embodiment, the pH value of the coating dispersion is between pH 6 and pH 9.5, preferred between pH 6.8 and pH 9.2, and particularly preferred between pH 8.1 and pH 9.0.

According to another embodiment the printing substrate used is a paper or paperboard made of woodfree pulp, whereas the use of additional components, such as fillers, pulp, etc. is also within the scope of the present invention.

According to a further particularly preferred embodiment the printing substrate may also be essentially produced from wood-containing pulp.

In a further embodiment the printing substrate is produced from a freely selectable portion of recycled paper of between 0 and 100%. However, it is also within the scope of the present invention to use combinations of the pulps previously illustrated.

According to a particularly preferred embodiment the printing substrate has an area weight of between 30 g/m² oven-dry and 250 g/m² oven-dry, preferred of between 32 g/m² oven-dry and 130 g/m² oven-dry, and particularly preferred of between 35 g/m² oven-dry and 100 g/m² oven-dry.

Woodfree, wood-containing coating paper, and coating paper containing up to 100% recycled paper, also with low area weight is suitable as the base paper.

Paper not suitable as the base paper is very strongly hydrophobized paper, i.e. highly sized mixture and surface sized coating papers. Highly glued mixture and/or surface sized coating papers are papers that are designated as fully sized papers according to prior art.

The coated paper produced with 100% recycled paper and different phyllosilicates, as well as with mixtures of other coating pigments, and 0.8 to 3.0 parts of the cross-linking compound without binding agent on a base paper shows good printing results and subsequent processing properties in all print processes. Furthermore, the cross-linking agents in particular also cause increased strength of the base paper.

In this regard it was shown that particularly matt and semi matt paper can be produced with this functional coat on phyllosilicate, or bentonite basis, respectively.

The use of suitable pigments, especially calcium carbonates, and a gentle calendering promote the matt effect in today's production of these types of papers. The surface roughness achieved in this manner promotes the desired diffuse reflection of light, but is simultaneously the cause of the increasing number of complaints in the matt paper area, e.g. lack of abrasion or smear resistance, lack of paperboard strength, and a degradation of the gravure printability.

Matt coated papers are most often processed in offset printing, because this print process is cable of balancing the rough surface with the aid of an elastic printing blanket made of rubber. Lately matt coated papers have also gained market shares in gravure printing. Gravure printing requires a very smooth surface, and a good compressibility of the papers. For good printability, a high smoothness of the paper is therefore of key importance, which—due to the strong calendering conditions—is in contrast with the requirement of low gloss.

The roughness of the surface obtained by means of the phyllosilicate, which is maintained even with very strong calendering, which in turn ensures high surface smoothness and good gravure printability, promotes the desired diffuse reflection of light, and therefore of the matt effect.

Matt coated paper with high surface smoothness enables the brilliant reproduction even with fine printing screens in offset and book printing, which expands the range of applications of such a paper from automobile, fashion, and cosmetic pamphlets, school books and catalogs, etc. Multipurpose writing and printing papers are written on, used as copy paper, and are printed on by means of offset and inkjet print processes.

Office papers must allow for this development, and have a good offset, laser, and color inkjet printability in addition to the primary suitability for copiers. The paper manufacturer should therefore supply a comprehensively functioning product that, if possible, meets all requirements, all printer types, and all ink formulations.

Currently, there are no multipurpose papers on the market that are equally suited for the different print processes and various printers.

It has been shown that an excellent printability in largely all print processes is achieved with the “functional coat” according to the invention.

By means of the high microcapillarity, or specific surface area of the functional coat (chromatography effect), an excellent inkjet printability is achieved with color printouts having a good color brilliance, optical density of the colors, and dot definition. These papers are furthermore characterized by rapid color drying, and higher water resistance. As the same print color is involved in the water-based flexoprinting process, i.e. anionic water soluble inks, the high specific surface area of the thin coat has an equal positive effect on the flexoprinting print quality, as with inkjet printing.

The acidic anionic, water soluble inks of inkjet and flexoprinting colors are anchored to the surface by means of rapid adsorption. Additionally, the high capillarity of the pigments supports the separating of inks and fluids by means of the chromatography effect. The larger ink molecules remain at the pigment surface, while smaller molecules, especially water and additives, are pulled into the interior of the pigments via capillary forces. This presupposes a high microcapillarity (specific surface area) with a predetermined pore radius, and/or improved water resistance.

Due to the high specific surface area of the very expensive silicates used today, their demand for binding agents is very high (up to 30-40 parts binder). Binding agents in turn are also relatively expensive, and allocate a large part of the surface so that the active surface is reduced.

In self-inking papers there are three different self-inking development systems (e.g. organic phenol resins doped with zinc ions, organic zinc salicylates, and inorganic, acidic activated bentonites) that exist for the coated front side.

In Europe, acidic activated bentonites are predominantly used as the coated front side layer. These bentonites with a high specific surface area and porosity have an anionic charge with numerous SiOH groups. These anionic groups at the interface react with cationic inks.

As with inkjet papers, contrary to the development according to the invention, the better part of the SiOH groups is also allocated in this case, or the specific surface area is reduced, respectively. With the development according to the invention, the high specific surface area is maintained.

According to a further particularly preferred embodiment the swollen phyllosilicates, and thus the pollutant emissions of the printing substrate due to heat of the coat applied on the exterior layer of the printing substrate absorb, such as they are released with the temperature treatment in laser printer processes for the fixing of the toner.

Increasing printing speeds in copiers require increased drying or fixing temperatures, which partially leads to the accumulation of pollutants and unpleasant odors in the respective rooms. Tests performed on laser printers with recycling paper have shown especially high concentrations of pollutants. Some of the main components were identified as 2,6-diisopropyl naphtaline, and tetramethyl biphenyl, which also lead to significant concentrations in offices.

Diisopropyl naphtaline (DIPN) has been used for the past 25 years as a solvent for self-inking papers. In 1994 residues of this solvent were first also detected in food in Italy. It was found that DIPN reaches food packaging made of recycled paper via the paper-recycling-circle, and once there, migrates into the food products.

As is generally known, bentonites have the special feature of binding foreign, aroma, and flavor additives, especially aromatics, and rendering them harmless. The bilateral bentonite layer of the functional coat according to the invention with the high specific surface area acts as an adsorption barrier, and therefore provides laser printers and copiers great relief of the pollutant concentrations.

Increasingly often requirements are made of newspaper printing presses to produce print products that meet an increased level of quality. For this reason, newspaper-like print objects are increasingly produced on improved or coated paper. However, high-quality coated coldset print papers, such as colored feature or advertisement inserts have now also been introduced to market. This is an obvious choice, because newspaper printing presses usually only work to capacity with the printing of the newspaper at night, and capacities for these types of orders are available during the day.

Since coldset print is a physical printing ink drying process, a high capillarity, or an open structure is demanded of coated paper.

By means of application of 1.5-3 g/m² of a functional coat with a high specific surface area, which forms an ideal condition for coldset print processes (ink penetration process), high-quality, low-grammage coated coldset print papers with high color density and color intensity may be produced using 100% recycled paper.

In the comparison between SC-A and SC-B paper (gravure print paper) to a functional coat equipped with 100% recycled paper, improved gravure printability is achieved—but especially offset printability (less deposits on the rubber printing blanket), no black calendering, and calendering deposits, improved brightness, and in the case of the production of papers with a low area weight no bleeding and showing through of the print ink.

As the pre-coat, the functional coat results in a rapid immobilization of the subsequent coat due to the high specific surface area, with the known advantages of a good coverage of the fibers with a barrier function with even coat distribution of the top coat, as well as cost savings. This barrier function may be further improved in liner paperboard by means of an additional low addition of a sizing agent to the functional coat.

This will also achieve a very good flexo-printability and inkjet printability, as well as a good further processing of the coated liner.

In comparison to LWC gravure matt paper the functional coat, especially with low grammages, shows a higher smoothness, fewer missing dots, higher print gloss with lower paper gloss, no glossy areas (friction gloss) in the further processing, as well as cost advantages.

In LWC offset matt papers, above all a low paper gloss, high print gloss, high smoothness, no glossy areas (friction gloss), improved print ink abrasion and smear resistance, low carbonizing, low mottling, higher residual breaking strength (avoiding of breakages within the fold), avoiding of blisters, and low coat costs are achieved.

The “breaking in the fold,” and the forming of blisters present a substantial problem for web offset papers.

The intense temperature exposure during multicolor offset printing not only has the effect of expelling volatile printing ink components, but also the embrittlement of the paper due to the volatilization of the water stored within the paper texture (up to 0% of water content). This may cause damages to the paper texture in the folding device, which may be noticed as “breakages in the fold,” or the breaking out of the stapling during subsequent processing.

Fold breakages preferred occur with increasing coat applications, with CaCO₃ as the coating pigment, with high binder portions (especially starch), and with high calendering conditions.

With high application amounts without any binding agents, fold breakages are counteracted with the functional coat due to the high aspect ratio, but especially also due to the hydrophilic character of the alkali activated bentonites, which retain a residual amount of water, thus reducing the risk of embrittlement.

In heatset web offset printing presses with the extremely high drying temperatures, water vapor is formed in the paper texture during the rapid heating of the printed paper web in the drying machine. Due to the bilateral covering with the paper coat and the printing color coat, the water vapor has no chance of multiply escaping. Fission in the paper texture, and thus a formation of blisters (blistering) occurs in the paper layer.

Measures leading to a densification and to a recession, or to the microcapillarity, respectively, of the coat, such as a high coat application, especially an increased synthetic material binding agent portion with high pressure and temperature, correspondingly have an adverse effect on blistering. Especially with high temperatures, such as soft calendering, the synthetic material binding agent often condenses, thus sealing the coat surface, which correspondingly has an adverse effect on blistering.

In the functional coat with a low coat application without any binding agents with high porosity, the water vapor can escape without any problems so that no risk of blistering exists.

The object of the invention is further that high qualities are achieved by means of the thin, functional application amounts according to the invention onto a base paper not only in all print processes, but due also to the low application amount, high production speeds and savings of binding agents, and in all cases also economical advantages may be achieved.

Another aspect of the invention is that the coated paper according to the invention has an excellent recycling behavior, because it contains no synthetic binders, and the cross-linking agents used have a temporary hardening effect, and can therefore be processed without any problems after a brief period of water exposure to the coated paper, as opposed to other cross-linking agents, such as HF, MF, epichlorohydrin resins.

Due to the surface finish of synthetic binders, they can form troublesome deposits in the material and process water cycles of de-inking machines and during coat broke reworking, and further can lead to wastewater contamination. Furthermore, this achieves an improvement of the de-inking capability.

Another aspect of the invention is a method for the production of a multifunctionally coated paper by means of application of a low reactive coat on the basis of alkali activated bentonites of between 0.8 to a maximum of 4 g/m² per page, without any binding agent, with a high binding capability by means of cross-linking reactions with special cross-linking agents on a base paper with a recycling paper portion of up to 100%, using a film press, curtain coater, or possibly by means of spraying application at production speeds of up to 2000 m/min, which has a comparable, if not improved print quality for conventional print processes, as well as in the specialty paper area, and which combines the economical advantages with an excellent recyclability.

Special mention should be made of the excellent offset capability of the functional coat according to the invention (application<4 g/m²), which has the same drying and wet pick resistances as coated LWC offset paper, which is known to make significantly higher demands of the coat setting due to higher print color viscosity and tackiness, than, for example, the gravure process, which is why coatings of LWC offset papers have up to 16 wt.-parts of binding agent.

The task of the invention is further also solved by means of a method for the production of a coated printing substrate in accordance with claim 33. Preferred embodiments are the object of the sub-claims.

According to the present invention a method for the production of a coated printing substrate involves the step of the mechanical application of a coating dispersion on the printing substrate. This coating dispersion consists of at least one predetermined portion of water, a predetermined portion of at least one swellable phyllosilicate, and one predetermined portion of a cross-linking agent, which binds both with at least one functional group of the phyllosilicate, and with at least one functional group of the printing substrate. As an additional step the method also comprises the drying of the coating dispersion applied.

According to a preferred embodiment of the present invention the printing substrate is calendered after coating and printing. The application of the coating dispersion occurs in accordance with a particularly preferred method of the present invention on the interior (Online), and/or on the exterior (Offline) of the paper machine. Coating devices known to prior art are utilized as the coating devices, including, for example, film presses, curtain coaters, spray coating, roll coating, . . . -over-roll coating, blade coaters, speed coaters, Massey process, flooded nip, and similar.

Devices offered on the market are, for example, the film presses by Jagenberg, von Voith, as well as the BTG company in Sweden and Metso.

The coatings may be applied both Online with a film press, and also with a new application system, such as curtain coating and spray coating (Opti-Spray) with application grammages of 0.5-4 g/m² at high speeds.

During curtain coating the pigment application is performed by means of a free falling, thin, of two free surface-limited fluid layers, the “curtain,” which enters onto the paper web in motion, and which forms the coating film.

The process represents an alternative to conventional application processes, with a trendsetting high-precision application technology, which promises high production speeds at low stresses of the paper web.

The Opti-Spray application system is a spray process, which is preferably also conducive to such thin coat applications.

The application speed of the coating dispersion occurs according to a further particularly preferred embodiment with a speed of between 150 m/min and 2300 m/min, preferred of between 200 m/min and 2100 m/min, and particularly preferred of between 500 m/min and 2000 m/min.

According to a further particularly preferred method of the present invention a coating dispersion is applied on the printing substrate, the area weight of which is between 0.5 and 6 g m² oven-dry, particularly preferred between 0.8 and 4 g/m² oven-dry, and according to a further particularly preferred embodiment, is particularly smaller than 4 g/m² oven-dry.

The printing substrate produced according to this method, and with the use of the coatings, and/or dispersions described, is suitable for the processing in at least one, particularly in a plurality of (multifunctional) print processes as are known from prior art. For example, this may be the offset print process, the gravure process, inkjet process, flexoprinting process, self-inking papers, heatset process, coldset process, laser printing, and such.

The use of the printing substrate according to the invention for the offset process, the gravure process, and/or for additional print processes, such as the inkjet process, flexoprinting process, laser printing process, self-inking paper, is also within the scope of the present invention.

According to the particularly preferred embodiment, the printing substrate is multifunctionally usable for various processes.

The invention will now be explained in detail by means of examples, whereas it is being noted that the illustrations are of exemplary character only, and are not intended to limit the invention itself. This is true in particular to the use of paper, or paperboard, respectively, as the printing substrate, whereas it is being noted that other materials, such as plastic foils, as the printed substrate may also be coated with the coating dispersion according to the invention.

They show:
Embodiment 1 use of an alkali activated bentonite for the coating of a thin coat paper;
Embodiment 2 use of an alkali activated bentonite with low amounts of binding agent for the coating of a thin coat paper;
Embodiment 3 use of wet strength agents in a coating dispersion according to the invention;
Embodiment 4 use of a modified cross-linking agent in the coating dispersion for the coating of a thin coat paper;
Embodiment 5 use of different silicates with a modified cross-linking agent in a coating dispersion;
Embodiment 6 production of a multifunctional paper on various printing substrates according to the present invention;
Embodiment 7 alternate embodiment for the production of a multifunctional paper with alkali activated bentonite;
Embodiment 8 embodiment of the coating of a paper with a coating dispersion according to the invention on a high-speed pilot coating machine.

Within the scope of the detailed description, particular reference is made to the offset capability of the functional coat (application<4 g/m²), which has the same drying and wet pick resistance as a coated LWC offset paper that is known to make significantly higher demands of the coat setting due to the high print color viscosity and tackiness, than, for example, the gravure process, which is why coatings of LWC offset papers have up to 16 wt.-parts of binding agent.

The invention is explained by means of the following examples in a non-limiting manner.

### EMBODIMENT 1

Production of a Thin Coat Paper With Alkali Activated Bentonite of Various Delamination Without Any Binding Agent.

Since the offset capability of a coated thin coat paper is the base for other coated papers, such as inkjet, flexoprinting, or self-inking paper, an offset printing evaluation of the various alkali activated bentonites without any binding agent was initially performed.

A 48 g/m² wood-containing, non-sized LWC coating base paper, as well as a 48 g/m² LWC coating base paper produced from 100% recycled paper, was used as the base paper.

For the production and delamination of the bentonite slurry (products of Süd Chemie, Munich) a high-performance dispersing device was used. The following bentonites were utilized: Printosil, Lightcoat, and Optigel. These products are described in detail in the product description issued by Süd-Chemie, Munich.

For the purpose of supporting the delamination, as well as for increasing the solid content, 0.2% of dispersing agent on polyacrylate basis was added. The pH values were between 8.0 and 9.0.

(Solid content according to DIN ISO 787 Part 2, pH value according to DIN ISO 787 Part 9, Low Shear Viscosity according to Brookfield at 100 r/pm according to DIN ISO 2555).

The bentonite slurries were applied to a wood-containing (w.c.), or AP containing coating base paper at an application amount of 1 g/m² by means of a motorized manual coating knife.

The paper surface-treated in this manner is calendered in a laboratory calender under the following conditions.
Reel surface temperature: 90° C.
Line strength: 250 N/mm
Speed: 10 m/min

Number of cycles 4

TABLE 1
Evaluation of the dry and wet pick resistance (offset)

| | | | | Dry picking | | Wet picking |
|---|---|---|---|---|---|---|
| | Solid | Viscosity | Dry picking | (base paper | Wet picking | (base paper |
| Bentonite | content | Brookfield 100 | (w.c. base | produced from | (w.c. base | produced from |
| type: | [%] | [mPa · s] | paper) | recycled paper) | paper) | recycled paper) |
| Printosil | 24.5 | 760 | − | − | − | − |
| Lightcoat | 13.4 | 650 | (−) | (−) | − | − |
| Optigel | 5.6 | 810 | (+) | (−) | − | − |

Legend:
−: fiber tearing
(−): slight fiber tearing
(+): slight picking
+: no picking

The evaluation of the printability in offset printing was performed using the test colors of the company Farbenfabriken Michael Huber, Munich (offset colors) in accordance with the “pick test” of the company Farbenfabriken M. Huber on the multi-purpose sample printing machine by Prüfbau.

All papers tested had an insufficient offset capability. With the paper coated with Lightcoat and Optigel 805, the dry pick resistance with the w.c. coated base paper resulted in slightly less fiber tearing, whereas the paper coated with Optigel 805 is assessed as slightly better.

### EMBODIMENT 2

Embodiment 2 relates to the production of a thin coat paper with alkali activated bentonite of various delamination with low amounts of binding agent.

In this test run PVAl (Mowiol 3-85), manufacturer KUARAI), cationed PVAl (Mowiol 3-85), and for digestion 6 parts of Poly-DADMAC (PolyQuad, manufacturer Kaptol-Chemie) were added. Furthermore, anionic starch (Perfectamyl A 4692, manufacturer AVEBE) was used as the binding agent. (Solid content of PVAl 30%, cationed PVAl 27%, and of the starch 25.5%).

For the dissolving of the PVA, as well as for the starch digestion, an automatic laboratory digester was used. The dispersion of the pigments was performed in a high-shear dispersing device (laboratory disperser with tooth wheel). For the mixing of the individual components, a laboratory mixer with propeller stirrer was used, whereas the methods stated in embodiment 1 were used for the measuring of the rheological properties.

As the pigments, Printosil and Lightcoat (manufacturer Süd-Chemie Munich) were used. After the dispersing, or delaminating, respectively, of the bentonite (see example 1), the respective binding agent amounts were added in wt.-parts, oven-dry. The pH values were between 8.0 and 9.0.

The coatings produced were applied on a coating base paper containing 100% recycled paper, and with an area-weight of 48 g/m², using a Helicoater.

This machine is the Helicoater 2000 by the company ECC (English China Clays), designed for the scrape coating process. In this process a highly concentrated coating is transferred on the paper web with the aid of a metal blade operating according to the scraping principle, which is pressed against a rubber-covered cylinder.

The carrier reel, on which the paper to be coated is stretched, consists of a hollow cylinder made of steel, which is additionally supported by ribs on the interior. The lateral frames consist of welded-in steel plates. A layer of hard rubber is attached on this cylinder. The reel can be accelerated up to a circumferential speed of 200 m/min.

The traversing pond serves as the color container and color application system, and therefore represents the heart of the machine.

The rear helicoater baffle contains the infrared drying unit. It consists of several rows of IR radiators used to dry the paper after coating.

The coatings were applied at a speed of 600 m/min.

The paper surface-treated in this manner is calendered in a laboratory calender under the following conditions:
Reel surface temperature: 90° C.
Line strength: 250 N/mm
Speed: 10 m/min
Number of cycles 4

The formulation, as well as the properties of the coating, and the evaluation of the coated paper are stated in table 2 as follows.

TABLE 2
Evaluation of the dry and wet pick resistance (offset)

| | Solid | Viscosity | Application | | |
|---|---|---|---|---|---|
| Bentonite type + | content | Brookfield 100 | grammage | Wet pick | Dry pick |
| Additive | [%] | [mPa · s] | [g/m²] | resistance | resistance |
| Printosoil + 1P PVA | 24.8 | 830 | 1 | − | − |
| Printosil + 3P PVA | 23.7 | 870 | 1 | (−) | (+) |
| Printosil + 3P PVA | 23.7 | 870 | 2.7 | − | − |
| Lightcoat + 1P PVA | 15.5 | 1120 | 1 | (+) | (+) |
| Lightcoat + 1P | 14.2 | 1250 | 1 | − | − |
| cationed PVA | | | | | |
| Lightcoat + 3P PVA | 15.7 | 1100 | 2.7 | − | (+) |
| Lightcoat + 3P starch | 14.8 | 900 | 2.7 | − | (−) |

Legend:
−: fiber tearing
(−): slight fiber tearing
(+): slight picking
+: no picking

The evaluation of the offset capability of the coated paper was performed according to embodiment 1.

The influence of the lamination of the bentonites on one hand, and the effect of the amount of binding agent on the other hand, as well as the application grammage are clearly identifiable from this test run. While the less delaminated bentonite (Printosil) with 1% PVAL still shows strong picking (fiber tearing), the stronger delaminated Lightcoat with 1% PVAl shows only slight picking.

A coating grammage increase has a negative effect particularly on the wet pick resistance despite of an increase in binding agent.

A cationization of PVAl further has a negative effect on the strength development. With the increasing addition of PVAl, especially with cationized PVAl, the ink penetration behavior (over 1800) decelerates, which may lead to deposits in the sheet offset.

The tests further show that in all papers tested, printability problems in offset printing can be expected.

Furthermore, the water resistance, or abrasion resistance in specialty papers, such as inkjet papers, should be insufficient.

### EMBODIMENT 3

Embodiment 3 refers to the use of wet strength agents (cross-linking agents) for improving the offset capability of thin coat paper.

The surface of coated paper and paperboard often comes into contact with water. For example, offset paper is exposed to moist water in the printing machine. Packaging paper is also exposed to moisture or wetness during transport. With specialty paper, such as coated inkjet paper, a certain wet strength resistance of the coat is also demanded.

In coats containing water soluble binding agents, the use also of additives, such as wet strength agents, can hardly be avoided. The effect of these products based in part on—as already described—cross-linking reactions with the water soluble binding agents in order to increase the wet strength resistance, which, however, do not contribute to the binding strength.

In this test run it was examined, whether wet strength agents are capable of entering into cross-linking reactions with the SiOH groups of the alkali activated bentonites, in order to therefore make a major contribution to the setting of the pigment particles among each other, as well as of the pigment particles to the base paper.

The following commercially available wet strength agents are used:

Zirconium carbonate (Cartabond ZA, manufacturer Clariant), urea formaldehyde resin (urecoll S, manufacturer BASF), melamine formaldehyde resin (Madurit 112, manufacturer Vianova), epichlorohydrin resin (Nadavin LTN, manufacturer Bayer), modified glyoxal resins (Cartabond TSI, manufacturer Clariant), polyisocyanate (Isovin, manufacturer Bayer).

The use of polyvinylamine (manufacturer BASF) was forgone, because it was shown that the strongly cationic polyvinylamine has the tendency to quench, or have a great adverse effect on the effectiveness of optical brighteners, and leads to certain viscosity problems due to the cationic charge.

The alkali activated bentonite used was Lightcoat (manufacturer Südchemie Munich). After dispersion, or delamination, respectively, of the bentonite (see example 1) the respective cross-linking amounts were added. The pH values were between 8.6 and 9.0. Furthermore, 2 parts of wet strength agent (oven-dry) each were added to this bentonite slurry by slowly adding it dose-by-dose while stirring. The coatings produced in this manner were applied on a coating base paper made of 100% recycled paper with an area weight of 48 g/m² using a motorized manual coating knife.

Analogous to embodiment 1, the paper surface-treated in this manner was calendered, and exposed to the same testing of the offset capability (sample printing machine).

TABLE 3
Evaluation of the dry and wet pick resistance (offset)

| | Solid | Viscosity | Application | | |
|---|---|---|---|---|---|
| Bentonite type + | content | Brookfield 100 | grammage | Wet pick | Dry pick |
| Additive | [%] | [mPa · s] | [g/m²] | resistance | resistance |
| Lightcoat + 1P | 12.8 | 920 | 2.5 | − | − |
| zirconium salt | | | | | |
| Lightcoat + 2P HF resin | 11.5 | 820 | 2.5 | (+) | (−) |
| Lightcoat + 2P MF resin | 11.8 | 760 | 2.5 | (+) | (+) |
| Lightcoat + 2P | 8.5 | 1100 | 2.5 | (+) | (−) |
| epichlorohydrin resin | | | | | |
| Lightcoat + 2P | 14.2 | 620 | 2.5 | + | + |
| glyoxal resin | | | | | |
| Lightcoat + 2P | 13.2 | 950 | 2.5 | + | (+) |
| polyisocyanate | | | | | |

Legend:
−: fiber tearing
(−): slight fiber tearing
(+): slight picking
+: no picking

The test results show that no improvements are achieved with zirconium, and certain improvements are achieved with HF resin, MF resin, and epichlorohydrin resin. As already mentioned, for reasons of ecology, effectiveness, handling, etc. these products were omitted in further optimizing works. Additionally, in the case of strongly cationic epichlorohydrin resin, great increases of viscosity were observed, which required a significantly lower solid content.

Very good results were achieved with polyisocyanate. Due to the already described problem with the use of this product, this product was forgone in later trials.

The best results with regard to dry and wet pick resistance (offset capability) were obtained with modified glyoxal (Cartabond TSI). The printability in this case is on the same level as a coated LWC offset paper with 14 parts of binder.

The test results surprisingly indicate that strong cross-linking reactions take place between the modified glyoxal, the SiOH groups of the bentonites, and the OH groups of the fibers.

### EMBODIMENT 4

Embodiment 4 relates to optimizing work with modified glyoxal (Cartabond TSI) for the development of a thin coat without any binder portion.

Further optimizing works with Cartabond TSI showed that in case of pH values larger than pH 9, and/or with increasing temperatures, particularly with longer residence times, increasing viscosity is determined, which in practice leads to processing problems. This effect increasingly occurred with the addition for Carrier of optical brighteners on PVAl basis.

Furthermore it was shown that due to the non-ionic character of Cartabond TSI, an incomplete adsorption of the product on the bentonite occurs, which leads to an increased consumption of the cross-linking agent.

The problem was successfully solved as described by means of a slight addition of PEG and PVAl to Cartabond TSI. This product, which is used in the following trials, is hereinafter referred to as “glyoxal compound,” whereas an optical brightener was additionally added.

Printosil and Lightcoat (manufacturer Südchemie, Munich) were used as the pigments.

After the dispersion, or delamination of the bentonites, respectively (see example 1), 2 parts of the cross-linking agents each were added. The pH value was adjusted to approximately 8.8.

The temperature of the slurry was adjusted to 35° C., and kept in motion while slightly stirring at residence times of 2 hours.

The coatings produced without any residence times were applied to a coating base paper containing 100% recycled paper and at an area weight of 48 g/m², using a helicoater (see example 2).

2.5 g/m² were applied to each side.

The paper surface-treated in this manner was calendered in a laboratory calender according to embodiment 1.

The evaluation of the printability in offset was also performed according to embodiment 1.

TABLE 4
Evaluation of the dry and wet pick resistance (offset)

| | | Viscosity | | |
|---|---|---|---|---|
| | Solid | Brook- | Wet pick | Dry pick |
| Bentonite type + | content | field 100 | resis- | resis- |
| Additive: | [%] | [mPa · s] | tance | tance |
| Printosil + 1P Cartabond | 23.7 | 640 | + | (+) |
| TSI 5 min. after | | | | |
| production | | | | |
| Printosil + 2P Cartabond | s. above | 810 | Not tested | Not tested |
| TSI 2 h after production | | | | |
| Printosil + 2P glyoxal | 23.2 | 590 | + | + |
| compound 5 min. after | | | | |
| production | | | | |
| Printosil + 2P glyoxal | s. above | 630 | Not tested | Not tested |
| compound 2 h after | | | | |
| production | | | | |
| Lightcoat + 2P Cartabond | 14.6 | 650 | + | + |
| TSI 5 min. after | | | | |
| production | | | | |
| Lightcoat + 2P Cartabond | s. above | 1050 | Not tested | Not tested |
| TSI 2 h after production | | | | |
| Lightcoat + 2P glyoxal | 14.1 | 630 | + | + |
| compound 5 min. after | | | | |
| production | | | | |
| Lightcoat + 2P glyoxal | s. above | 660 | Not tested | Not tested |
| compound 2 h after | | | | |
| production | | | | |

Legend:
−: fiber tearing
(−): slight fiber tearing
(+): slight picking
+: no picking

The test results show that after a residence time of only 2 hours an increase in viscosity occurs in Cartabond TSI, and both in Printosil and Lightcoat, which in the case of Lightcoat is even more pronounced due to the greater delamination (cross-linking reaction).

This increase in viscosity is strongly increased with pH values of <9.0, as well as with the addition of PVAl carrier, as further tests have shown.

No viscosity increase was registered with the “glyoxal compound” with a pH value of 9.0, and even with a PVAl addition. It was shown, however, that a pH value of over 9.1 should be avoided.

The tests further show that with 2 parts of Cartabond TSI with a coating application of 2.5 g/m² with the less activated Printosil results in slight picking, and in the case of the stronger activated Lightcoat with the higher SiOH group portion, on the other hand, no picking problems were found.

The tests further show that with Printosil with the “glyoxal compound” also no picking problems occurred due to the better adsorption and effectiveness. Excellent inkjet printabilities on the printers HP CP 1160, HP 895CXI, Epson C 80, and Canon J 750 were also obtained with these coated papers.

### EMBODIMENT 5

Embodiment 5 relates to the examination of the offset capability of various silicates with different specific surface areas by means of cross-linking reactions with the “glyoxal compound”.

For this purpose, a kaolin (CamCoat 80, manufacturer Amberger Kaolinwerke E. Kick GmbH) at an amount of 12 m²/g, an alkali activated bentonite (Copisil N401, manufacturer Süd-Chemie, Munich) with a surface of approximately 340 m²/g, and a precipitated Na-aluminum silicate (Zeocopy, manufacturer J.M. Cooperation) with a surface of approximately 200 m²/g were used for the tests.

After dispersion (see embodiment 1) with 0.3 dispersing agent (polyacrylate basis), and pH adjustment with sodium hydroxide solution to 8.5, 2% oven-dry of the cross-linking agent glyoxal compound was added.

The pigment slurry was applied to an AP-containing coating base paper (48 g/m²) at an application amount of 3 g/m² as according to embodiment 1 by means of a manual coating knife.

The paper surface-treated in this manner is calendered in a laboratory calender according to embodiment 1.

The evaluation of the printability in offset was again performed according to embodiment 1.

TABLE 5
Evaluation of the dry and wet pick resistance (offset)

| | | Viscosity | | |
|---|---|---|---|---|
| | Solid | Brook- | Wet pick | Dry pick |
| Pigment type + | content | field 100 | resis- | resis- |
| Additive | [%] | [mPa · s] | tance | tance |
| Kaolin (Camcoat 80) | 55 | 840 | − | − |
| Alkali activated bentonite | 37.8 | 830 | (+) | (−) |
| (Copizil N407) | | | | |
| Al-silicate (Zeocopy) | 60.4 | 870 | (+) | (+) |

Legend:
−: fiber tearing
(−): slight fiber tearing
(+): slight picking
+: no picking

The tests show that strong picking, or a fiber tearing, respectively, occurs with a 3 g/m² coating application with kaolin. With the use of an alkali activated bentonite, the paper shows a slight fiber tearing during dry picking. Slight wet picking was also observed. With the use of precipitated Al-silicate, only slight picking with few fiber tears occurred both during dry and wet picking. As opposed to kaolin, a certain cross-linking reaction by means of the higher specific surface area can be observed in the silicates, which, however, is not sufficient for an offset capability.

With low application grammages, such as up to 1.5 g/m², or higher cross-linking agent amounts, a sufficient cross-linking reaction cannot be excluded.

### EMBODIMENT 6

Embodiment 6 shows the suitability of various coating base papers for the production of multifunctional papers.

The coating base paper used was a 48 g/m² wood-containing, non-glued LWC coating base paper, a slightly glued, wood-containing, 54 g/m² coating base paper, a woodfree (w.f.), non-sized 70 g/m² coating base paper, a woodfree, slightly sized 80 g/m² coating base paper, and a woodfree, strongly sized (mass and surface sizend with a synthetic hydrophobing agent) 82 g/m² coating base paper. The suitability of coating base paper made with 100% recycled paper for a multifunctional paper was already proven in embodiments 3 and 4.

For the tests an alkali activated bentonite (Lightcoat, manufacturer Süd-Chemie Munich) was used, which was prepared according to embodiment 1, and applied with a helicoater, as described in embodiment 2.

The cross-linking agent used was 1.7% oven-dry of glyoxal compound. The pH value was adjusted to 8.8. The solid content was 14.2% at a Brookfield viscosity (100) of 690 mPa•s. The paper surface-treated in this manner was calendered according to embodiment 1, and the offset capability was evaluated.

TABLE 6
Evaluation of the dry and wet pick resistance (offset)

| | Application | Wet pick | Dry pick |
|---|---|---|---|
| Pigment type + coating base paper | grammage | resis- | resis- |
| Additive | [g/m²] | tance | tance |
| Lightcoat + non-sized w.c., | 3.0 | + | + |
| 48 g/m² coating base paper | | | |
| Lightcoat + slightly sized w.c., | 3.5 | + | (+) |
| 54 g/m² coating base paper | | | |
| Lightcoat + non-sized w.f., | 3.0 | + | + |
| 70 g/m² coating base paper | | | |
| Lightcoat + slightly sized w.f., | 3.5 | + | + |
| 80 g/m² coating base paper | | | |
| Lightcoat + strongly sized w.f., | <1.0 | + | (+) |
| 82 g/m² coating base paper | | | |

Legend:
−: fiber tearing
(−): slight fiber tearing
(+): slight picking
+: no picking

The coating base papers tested are all suitable for the thin coat method according to the invention, with the exception of the strongly sized w.f. coating base paper. Problems with the cross-linking occurred in this paper, i.e. the desired application amount could not be applied.

Furthermore, a sufficient amount of functional groups is no longer available for the cross-linking reaction with the glyoxal compound.

Excellent inkjet printabilities were also obtained with these coated papers on the printers HP CP 1160, HP 895CXI, Epson C 80, and Canon J 750.

### EMBODIMENT 7

Embodiment 7 refers to the determination of the thresholds of pigment mixtures with alkali activated bentonite for the production of multifunctional paper.

The following coating pigments were used for the tests: kaolin (Camcoat 80, manufacturer AKW-Kick), ground calcium carbonate GCC (Hydrocarb, manufacturer Omya), precipitated calcium carbonate PCC (Socal P2, manufacturer Solvay), precipitated Al-silicate (Zeocopy, manufacturer J. M. Huber Corporation), and a synthetic calcium silicate produced on they hydrothermal process (Circolit, manufacturer Cirkel). Lightcoat (manufacturer Süd-Chemie, Munich) was used as the alkali activated bentonite.

The delaminated and dispersed bentonite (see embodiment 1) is placed in a receiving flask and the respective coating pigment is added at the desired amount dose-by-dose while stirring. As additional additives, 1% of oven-dry PVAl (Mowio13-83) as the carrier, and 0.5% of an optical brightener (Leukophor AL, manufacturer Clariant) were added dose-by-dose. As the last component, 2.5% of oven-dry glyoxal compound cross-linking agent was added.

The pH value was adjusted to 8.8 with sodium hydroxide solution. The pH in the Circolit mixture was adjusted to a pH of 8.8 with hydrochloric acid.

The coatings produced were applied on a coating base paper made with 100% recycled paper at an area weight of 48 g/m² using a helicoater as described in embodiment 2. An amount of 2 g/m² was used for each application.

The paper surface-treated in this manner is calendered in a laboratory calender according to embodiment 1.

TABLE 7
Evaluation of the dry and wet pick resistance (offset)

| | | Solid | Viscosity | | |
|---|---|---|---|---|---|
| | Pigment | content | Brookfield 100 | Wet pick | Dry pick |
| No | mixtures | [%] | [mPa · s] | resistance | resistance |
| 1 | 100P Lightcoat | 14.6 | 880 | + | + |
| 2 | 90P Lightcoat + 10P | 17.2 | 920 | + | + |
| | kaolin Camcoat 80 | | | | |
| 2a | 80P Lightcoat + 20P | 20.6 | 1100 | (+) | + |
| | kaolin Camcoat 80 | | | | |
| 3 | 90P Lightcoat + 10P nat. | 18.8 | 790 | + | + |
| | CaCO₃ Hydrocarb 90 | | | | |
| 3a | 80P Lightcoat + 20P nat. | 23.2 | 960 | (+) | + |
| | CaCO₃ Hydrocarb 90 | | | | |
| 4 | 90P Lightcoat + 10P prec. | 17.2 | 680 | + | + |
| | CaCO₃ PCC Socal P2 | | | | |
| 4a | 80P Lightcoat + 20P prec. | 23.1 | 1200 | (+) | + |
| | CaCO₃ PCC Socal P2 | | | | |
| 5 | 90P Lightcoat + 10P | 16.5 | 740 | + | + |
| | Al-silicate Zeocopy | | | | |
| 5a | 80P Lightcoat + 20P | 20.5 | 860 | + | + |
| | Al-silicate Zeocopy | | | | |
| 6 | 90P Lightcoat + 10P | 16.8 | 940 | + | + |
| | Ca-hydrosilicate Circolit | | | | |
| 6a | 80P Lightcoat + 20P | | | | |
| | Al-silicate Zeocopy | | | | |

Legend:
−: fiber tearing
(−): slight fiber tearing
(+): slight picking
+: no picking

Table 8 shows the test results of the paper test, and table 9 summarizes the offset suitability of the coated papers. Furthermore, an evaluation of the printability in gravure, flexoprinting, inkjet printing, laser printing, and self-inking papers (SI) was performed.

TABLE 8
Paper Test (Example 7)

| | | Smoothness | Brightness | |
|---|---|---|---|---|
| Paper No. | Gloss 75° | (Bekk) sec | 457 with UV | Opacity |
| 1 | 22.5 | 1816 | 70.1 | 89.5 |
| 2 | 23.7 | 1780 | 71.2 | 89.0 |
| 2a | 26.5 | 1690 | 72.8 | 88.7 |
| 3 | 21.2 | 1640 | 71.9 | 89.2 |
| 3a | 20.8 | 1540 | 73.8 | 88.9 |
| 4 | 22.8 | 1680 | 72.1 | 89.6 |
| 4a | 24.1 | 1760 | 74.1 | 90.2 |
| 5 | 21.6 | 1570 | 72.0 | 89.4 |
| 5a | 23.2 | 1490 | 74.6 | 90.8 |
| 6 | 26.8 | 1790 | 72.8 | 89.7 |

TABLE 9
Evaluation of the offset suitability (Example 7)

| | | | Ink penetration |
|---|---|---|---|
| Paper No | Print gloss | Optical density | behavior [sec.] |
| 1 | 14 | 1.38 | 1500 |
| 2 | 14 | 1.40 | 1100 |
| 2a | 15 | 1.42 | 1300 |
| 3 | 14 | 1.43 | 900 |
| 3A | 15 | 1.48 | 700 |
| 4 | 15 | 1.45 | 900 |
| 4a | 15 | 1.49 | 700 |
| 5 | 14 | 1.32 | 800 |
| 5a | 14 | 1.39 | 600 |
| 6 | 15 | 1.44 | 800 |

The mottling test showed no signs of mottling of the printing image.
gloss and density, no significant difference were detected
seat and printout behavior are assessed as good
tearing zone within the favorable range in all samples
missing dots, good results were achieved (0-1) also in this aspect
0—no missing dots
1—few
2—many
   Evaluation of the Printability in Flexoprinting, Inkjet, Laser Printing, and SD Printability.
   Flexoprinting (Embodiment 7)

Printing machine: W+4

Printing ink: Michael Huber, water based

In all papers the evaluation of the papers tested showed a good flexo-printability with slightly lower print gloss and density values as opposed to a standard flexoprinting paper. The coated papers 2a, 4a, and 6 shows slightly better print gloss and density values.

Inkjet Printing (Embodiment 7)

The test results showed that due to the “functional coat” of the thin coat papers an excellent inkjet printability with color printouts can be obtained with the HP CP 1160, H 895 Cxi, HP 950, Epson C 80, and the Canon J750, which clearly differed from conventionally coated and surface-glued papers with regard to color brilliance, optical density of the colors, dot definition, bleeding, and mottling. The thin coat papers are additionally distinguished by rapid color drying (increase of smear resistance), and a higher water resistance.

Of course, in addition to the printer type used, the inkjet printing results of the thin coat papers are strongly influenced by the inks. For example, a good color brilliance was achieved with the Canon BJ2000 due to an unpigmented ink, which, however, has a tendency of a strong running of the ink, which partially leads to bleeding. However, an excellent inkjet result could be achieved with a functional coat using a glued paper. A significant improvement could also be achieved by adding 0.2% AKD.

Laser Printing (Embodiment 7)

The evaluation of the laser printability, or the determination of the toner adhesion shows that a good laser printability can be achieved with the tested thin coat papers, which, however, fell slightly below the values of the offset standard with regard to print failure, as well as toner adhesion (in accordance with PTC work instruction PVT-AAW001).

SD Printer Evaluation (CF Layer) (Embodiment 7)

The test results showed that a good SD lettering can be obtained with all thin coat papers, which shows slight disadvantages as opposed to a standard with an acidic activated bentonite (Copisil) with high coat grammages.

The coated samples 4a, 5a, and 6 showed the best results.

Sample 5a comes very close to the standard quality.

Methods of Determination for the Paper Testing and Printability Evaluation:

measurement of the reflection coefficient R457 (brightness measurement)
determination of opacity according to DIN 53 146/3 (1979)
measurement of gloss according to ZM V/22/72
smoothness according to Bekk in accordance with DIN 53 107/8 (1975)
printability test with the offset sample printing machine.

The following printability tests were performed (also see “test methods in offset for printing colors and print media Michael Huber, Munich, 2^{nd} Edition):
ink penetration test (ink penetration behavior of inks)
pick test (determining the pick resistance)
wet pick test (consideration of the moistening of offset print paper)
evaluation of the print gloss
mottling test
printability test in gravure printing was performed using the sample printing machine Testacolor by Prüfbau Einlehner.

### EMBODIMENT 8

Embodiment 8 refers to coating tests that were performed on a high-speed pilot coating machine at a scale of 1:1.

In order to corroborate the results of previous laboratory and pilot plant station tests under practical conditions, various alkali activated bentonites (Printosil, Lightcoat, manufacturer Südchemie Munich), and the additives optimized in previous tests, were coated using a high-speed pilot coating machine at a scale of 1:1. The dispersion, or delamination of the bentonites, respectively (see embodiment 1) had already been performed at the manufacturer's plant with the aid of a dispersing agent on polyacrylate basis, and the shipment was made in slurry form with solid contents of between 12 and 21%. As the additional pigments, for increasing the whiteness and fiber coverage with simultaneous cost optimizing, a Brazilian coating kaolin (Capim DG, manufacturer Imerys, St. Austell) and a calcium silicate produced on hydrothermal basis (Circolit, manufacturer Cirkel, Haltern am See) were used, which were also shipped in slurry form.

Furthermore, a glyoxal compound (see embodiment 4), polyvinyl alcohol (Mowiol 3-85, manufacturer Kuarai), and a modified polyvinyl alcohol (Mowiol 3-85, manufacturer Kuarai), as well as an optical brightener (Leukophor AL, manufacturer Clariant, Muttenez), and in a test run, an offset binder (Baystal 7110) were used.

In order to improve the rheological properties of the highly desired production speeds of up to 1800 m/min, a thickener (Sterocoll SL, manufacturer BASF Ludwigshafen) was additionally used.

A paper based on 100% recycled paper with an area weight of 54 g/m² and a strongly surface-sized, woodfree coating base paper with an area weight of 80 g/m² served as the coating base papers.

Description of the Pilot Coating Machine:

In order to meet their manifold tasks, the following machines and equipment was available:
coating preparation with 3 rotor stator systems (GAW VST “variable shear technology”) for the “super dispersion” of pigments,
batch and jet digesters for starch preparation
coating machine (width 59 cm) with reel and nozzle application system with stiff or bent blade, or reel coater, as well as with film press with all prevalent pre-dosing systems for coating speeds of between 50 m/min and 2500 m/min
12-reel super calender with 2 heating circuits
slitter rewinder
paper test station

Technical Description:

| | |
|---|---|
| Rewinding, reeling | Jagenberg |
| Drive | Siemens Master Drives |
| Quality control system | Measurex |
| Process control system | GAW/M + R |
| Pull measurement | ABB, bilateral |
| Web edge guide control | Erhardt & Leimer |
| Drying | Krieger |
| | INFRA-AIR dryer |
| | CB-AIR dryer |

Coating device: FILMPRESS by Jagenberg in combination with VARI-BAR, smooth (20 mm-38 mm), or grooved (12 mm-38 mm)
   Technical Data:
Working width: 590 mm
Finished paper width: 560 mm
Grammage range: 28-600 g/m²
Application grammage/side (oven-dry): 0.0 (water)-approx. 22 g/m²
Working speed: 50-2500 m/min
Max. reel diameter: 1500 mm
Core diameter: 76/150 mm
Smallest test unit: 1 reel

Coating Preparation:

| | |
|---|---|
| Mixer | GAW-VST 180-750 1 |
| Batch digester | 5-50 1, 50-400 1 |
| Nozzle digester | 500-1000 1 |
| Charge amounts | 200-400 kg oven-dry pigment |
| max. solid content | approx. 78% |
| max. viscosity | approx. 7000 mPa · s |

Optional dosage either manually, or automatically

Super Calender:

| Type | Voith Sulzer, 12 reels | |
|---|---|---|
| Speed | 50-600 | m/min |
| Uniform load | 110-320 | kN/m |
| Temperature | 40-95° | C. |

All trials were performed using the application system film press. This application system enables the simultaneous application of the coating onto both sides at very high speeds.

The following test runs were performed:

| Pigment/ | | | | | | |
|---|---|---|---|---|---|---|
| additive/ | | | | | | |
| parameter | V1 | V2 | V3 | V4 | V5 | V6 |
| Lightcoat | 100 | 100 | | | | |
| Printosil | | | 100 | 100 | 98 | 75 |
| Capim DG | | | | | | 25 |
| Circolit | | | | | 2 | |
| Optical | 0.5 | 0.5 | 0.5 | 0.5 | 0.6 | 0.8 |
| brightener | | | | | | |
| PVA | 0.8 | | | 0.8 | 0.8 | 1.3 |
| Mod. PVA | | 1.5 | | | | |
| Glyoxal | 1.5 | 1.7 | 2.0 | 1.8 | 1.8 | 1.7 |
| compound | | | | | | |
| Sterocoll SL | 0.2 | | 0.1 | 0.2 | 0.1 | 0.1 |
| Baystal 7110 | | | | | | 2.0 |
| pH value | 8.5 | 8.5 | 8.5 | 8.7 | 9.1 | 7.8 |
| Viscosity | 290 | 850 | 620 | 460 | 210 | 360 |
| Brookfield | | | | | | |
| 100 RPM [%] | | | | | | |
| Solid | 14.4 | 13.3 | 22.6 | 22.4 | 23.9 | 25.5 |
| content [%] | | | | | | |
| Paper: | AP | AP | AP | AP | h′f′ | AP |
| | material | material | material | material | glued | material |
| Coating | C25 | C25 | C22 | C22 | C30 | C30 |
| knife type | | | | | | |
| Speed | 1000 | 1000 | 1800 | 1800 | 1800 | 1800 |
| [m/min] | | | | | | |
| Application | 2.1 | 1.9 | 1.9 | 2.1 | 0.5 | 2.2 |
| grammage per | | | | | | |
| side [g/m²] | | | | | | |

All information stated in wt.-parts oven-dry (except for optical brightener, here as commercially available product)

For the adjustment of the pH values, 10% NaOH solution was used as required.

The production speed was at Va and V2, not at the originally planned 1800 m/min, because problems occurred due to a residual moisture that was too high, or due to a low solid content of the coatings, respectively, (drying problem). A stable run was possible up to 1000 m/min.

With V5, not more than 0.5 g/m² could be transferred to the paper web despite of the modification of the contact pressures of the coating knifes, and the modification of the nip pressure of the film press.

As was already shown in embodiment 6, a coating transfer from the application reels to the paper is nearly impossible due to the hydrophobic (glued) surface of the woodfree paper used.

The coated papers V1-V6 were calendered on the super calender under the following conditions:

| | | |
|---|---|---|
| Speed | 600 | m/min |
| Uniform load | 180 | kN/m |
| Temperature | 90° | C. |

Analogously to embodiment 7, the papers surface-treated in this manner were exposed to the same test of offset capability, gravure printability, flexoprinting suitability, laser and inkjet suitability. A LWS offset, and a LWC gravure paper were used for comparison, i.e. a typical offset ink with 80 parts of CaCO₃, 20 parts of kaolin, and 12 parts of binder, or a typical gravure ink with 80 parts of kaolin and 20 parts of talc, as well as 5 parts of binder were applied at 7 g/m².

An accurate recording of the quality parameters of the unprinted and printed samples was also performed:

| | | | | | | | LWC | LWC |
|---|---|---|---|---|---|---|---|---|
| Parameter | V1 | V2 | V3 | V4 | V5 | V6 | offset | gravure |
| Brightness R457 with UV | 76.1 | 76.6 | 77.2 | 76.8 | 86.8 | 79.5 | 85.6 | 76.5 |
| Opacity | 91.7 | 91.8 | 91.8 | 91.5 | 95.2 | 93.6 | 94.0 | 93.8 |
| Paper gloss (45°) | 15.1 | 16.7 | 15.5 | 16.1 | 16.8 | 17.8 | 40.3 | 49.7 |
| Print gloss (60°) | 5 | 5 | 5 | 5 | 5 | 5 | 14 | 8 |
| Mottling | Hardly any | Hardly any | Hardly any | Hardly any | slight | Hardly any | Hardly any | — |
| | mottling | mottling | mottling | mottling | mottling | mottling | mottling | |
| Ink penetration test [s] | 600 | 600 | 600 | 600 | 800 | 500 | 300 | — |
| Wet pick test | No | No | No | No | No | No | No | — |
| | picking | picking | picking | picking | picking | picking | picking | |
| Dry pick test | No | No | No | No | No | No | No | — |
| | picking | picking | picking | picking | picking | picking | picking | |
| Missing dots | Few | Few | Very few | Few | Many | Very few | — | Very few |
| Print quietness (seat) | Good | Good | Good | Good | Medium | Very good | — | Very good |
| Flexoprinting suitability | Suited | Suited | Suited | Suited | Poor | Good | — | Good |
| Inkjet printability | Good | Good | Very good | Good | Good | Good | Poor | Very poor |
| Laser printability | Good | Good | Good | Good | Very good | Good | Very good | Good |

The performance of the offset, flexoprinting, and laser printing evaluation is described in embodiment 7. The gravure printability test was performed by M. Huber Farbenwerke on a printing machine (Testacolor) with a print ink S.W. (illustrations gravure ink, toluene based). The LWC offset and gravure papers were each tested only on the printability predetermined for these papers.

The inkjet printability was performed on each of the HP CP1160, HP 895Cxi, Epson C80, and Canon J 750 printers.

The test runs performed, and the extensive evaluation of the trials lead to the following conclusions:
Samples V1-V6 are printable in all prevalent print processes (offset, flexoprinting, gravure, laser, and inkjet) with good results (with exception of V5).
The ink penetration behavior in offset print can be classified as good.
In offset print, all samples hardly showed any mottling at all (V5 slight mottling).
Both the wet and the dry picking of all samples can be classified as good to very good.
In gravure, all samples, with the exception of V5, show a good seat and print quietness.
In flexoprinting, satisfactory print results can be achieved; V5 is not printable in flexoprinting.

The application of a functional coat with 2 g/m² achieves an offset capability, such as of a LWC offset paper with 12 parts of binder, and a coating application of 7 g/m². The binder-free coating layer with a high specific surface area also ensures a good gravure, flexoprinting, and inkjet printability.

This represents, particularly for the matt paper area, a new development of coated papers with high quality properties and low costs as compared to the standard papers.

Having described and illustrated the principles of the invention in a preferred embodiment thereof, it should be apparent that the invention can be modified in arrangement and detail without departing from such principles. We claim all modifications and variation coming within the spirit and scope of the following claims.

1. A coating dispersion for the coating of printing substrates, including one or more of paper and paperboard, the coating dispersion comprising:
a predetermined portion of water;
a predetermined portion of at least one swellable phyllosilicate;
a predetermined portion of a cross-linking agent, which forms a chemical bond both with at least one silanol group of the phyllosilicate, and also with at least one functional group of the printing substrate.

2. A coating dispersion according to claim 1, characterized in that the coating grammage per side on the printing substrate is preferred between 0.5 and 6 g/m² oven-dry, particularly preferred between 0.8 and 4 g/m² oven-dry, and particularly smaller than 4 g/m² oven-dry.

3. A coating dispersion according to claim 1, characterized in that the swellable phyllosilicate is at least one smectic phyllosilicate from a group of phyllosilicates containing bentonites, alkali bentonites, Wyoming bentonite, montmorillonite, hectorite, saponite, nontronite, alkali phyllosilicate, earth alkali phyllosilicate, calcium bentonite.

4. A coating dispersion according to claim 3, characterized in that the phyllosilicate is activated, whereas the activation is achieved in particular by means of adding an aqueous solution of sodium hydroxide, and/or by means of a mechanical dispersion at a predetermined viscosity.

5. A coating dispersion according to claim 1, characterized in that the cross-linking agent has at least one component from a group of components including wet strength agents, such as formaldehyde (UF), melamine formaldehyde resins, aliphatic epoxy resins, epichlorohydrin resins, polyamide-polyamine epichlorohydrin resins (PAMMAM-EPI), zirconium compounds, glyoxal compounds, polyisocyanates, alkyl ketone dimmers (AKD), alkyl succinct anhydrides (ASA), and polyvinyl amines.

6. A coating dispersion according to claim 5, characterized in that the cross-linking agent glyoxal is, in particular, a modified glyoxal compound.

7. A coating dispersion according to claim 5, characterized in that a portion of between 2 and 10 wt.-% oven-dry, preferred between 4 and 7 wt.-% oven-dry of polyvinyl alcohol (PVAl) is added to the cross-linking agent.

8. A coating dispersion according to claim 5, characterized in that a portion of between 2 and 6 wt.-% oven-dry, preferred between 3 and 5 wt.-% oven-dry of polyethylene glycol (PEG) is added to the cross-linking agent.

9. A coating dispersion according to claim 1, characterized in that at least one extender pigment is added to the coating dispersion, which is selected from a group of pigments containing precipitated silicate, acidic activated bentonite, silicate produced on hydrothermal process basis, zeolite, aluminum hydroxide.

10. A coating dispersion according to claim 9, characterized in that at least one extender pigment (additional pigment) is added to the coating dispersion, which is selected from a group of pigments containing kaolin, ground calcium carbonate (GCC), precipitated calcium carbonate (PCC), talc, titanium dioxide.

11. A coating dispersion according to claim 1, characterized in that the cross-linking agent effects a bond, particularly a cross-linking with the phyllosilicate, and/or with pulp, or hydrocolloids, starch, CMC, or polyvinyl alcohol.

12. A coating dispersion according to claim 1, characterized in that the cross-linking reaction occurs between the functional groups of the cross-linking agent, and the functional groups of the swellable phyllosilicates, particularly the silicol groups, and the functional groups of the pulp, particularly the free hydroxyl groups.

13. A coating dispersion according to claim 1, characterized in that the functional group of the cross-linking agent is free hydroxyl groups with the use of a mixed product of glyoxal with polyethylene glycol (PEG), and/or polyvinyl alcohol (PVAl).

14. A coating dispersion according to claim 1, characterized in that the functional group of the cross-linking agent is free aldehyde groups with the use of a mixed product of glyoxal and polyacrylamide (PAM).

15. A coating dispersion according to claim 1, characterized in that the pH value of the coating dispersion is adjusted to between pH 6 and pH 9.5, preferred between pH 6.8 and pH 9.2, and particularly preferred between pH 8.1 and pH 9.0.

16. A coating dispersion according to claim 1, characterized in that the bond is at least a bond of a group of bonds having covalent bonds, hydrogen bonds, van der Waals bonds, ionic bonds, and/or any desired blends.

17. Method for producing a coated printed substrate, comprising:
machine application of a coating dispersion on a printing substrate, whereas the coating dispersion has at least the following components:
a predetermined portion of water;
a predetermined portion of at least one swellable phyllosilicate;
a predetermined portion of a cross-linking agent, which forms a bond both with at least one functional group of the phyllosilicate, and with at least one functional group of the printing substrate;
drying of the coating dispersion applied.

18. Method for producing a coated printing substrate according to claim 17, characterized in that a coating is applied on a printing substrate comprising paper or paperboard.

19. A coated printing substrate made according to the process of claim 17 in which the substrate comprises at least one of paper and paperboard.

20. Use of a coated printing substrate according to claim 19 for a print processes selected from the group comprising offset print process, gravure process, inkjet process, flexoprinting process, laser printing process, and self-inking paper.
